(19) United States
(12) Patent Application Publication
(10) Pub. No.: US 2018/0321070 A1
(43) Pub. Date: Nov. 8, 2018

(54) DEVICE AND METHOD FOR MEASURING AN AMOUNT OF WATER DISPENSED THROUGH A FAUCET SPOUT

(71) Applicant: JORDAN VELESTUK, EMERALD PARK (CA)

(72) Inventor: JORDAN VELESTUK, EMERALD PARK (CA)

(21) Appl. No.: 15/589,262

(22) Filed: May 8, 2017

(51) Int. Cl. G01F 15/00; G01F 1/00

(52) U.S. Cl. CPC G01F 15/003; G01F 1/00

(57) ABSTRACT

A device for measuring an amount of water dispensed through a faucet spout is provided. The device comprises housing. A water conduit is disposed in the housing. A first end of the water conduit is adapted for being mounted to the faucet spout. A water flow meter is disposed in the water conduit for sensing a water flow through the water conduit and for providing a water flow signal indicative thereof. A microprocessor is disposed in the housing and connected to the water flow meter for determining the amount of water dispensed through the faucet spout in dependence upon the water flow signal and for providing data indicative thereof.

### FIELD OF THE INVENTION

The present invention relates to water metering devices, and more particularly to a device and method for measuring an amount of water dispensed through a faucet spout.

### BACKGROUND OF THE INVENTION

In numerous situations—for example, when working in a kitchen or a laboratory—it is desirable or even necessary to measure an amount of water used. Typically, this is done using measuring cups, measuring spoons, or Pyrex jars. Unfortunately, using such conventional measuring devices, measuring an accurate amount of water can be time-consuming and cumbersome. Normally, such a measuring process requires several steps of: filling the measuring device until the water level is proximate a marker indicating the desired amount; stopping filling; removing the measuring device from the faucet spout; checking if the water level is proximate the marker while trying holding the measuring device level or placing it onto a level surface; and, repeating the previous steps until the water level is sufficiently close to the marker.

Sometimes it is also desirable to adjust the temperature of the water dispensed through a faucet spout. Typically, this is done by mixing hot and cold water and feeling the temperature of the dispensed water by hand, resulting in a very inaccurate temperature measurement.

It is desirable to provide a device and method for measuring an amount of water dispensed through a faucet spout.

It is also desirable to provide a device for measuring an amount of water dispensed through a faucet spout that is sufficiently small for being attached to or integrated into a faucet spout.

It is also desirable to provide a device and method for measuring a temperature of water dispensed through a faucet spout.

It is also desirable to provide a device for measuring an amount of water dispensed through a faucet spout that enables wireless communication therewith.

### SUMMARY OF THE INVENTION

Accordingly, one object of the present invention is to provide a device and method for measuring an amount of water dispensed through a faucet spout.

Another object of the present invention is to provide a device for measuring an amount of water dispensed through a faucet spout that is sufficiently small for being attached to or integrated into a faucet spout.

Another object of the present invention is to provide a device and method for measuring a temperature of water dispensed through a faucet spout.

Another object of the present invention is to provide a device for measuring an amount of water dispensed through a faucet spout that enables wireless communication therewith.

According to one aspect of the present invention, there is provided a device for measuring an amount of water dispensed through a faucet spout. The device comprises housing. A water conduit is disposed in the housing. A first end of the water conduit is adapted for being mounted to the faucet spout. A water flow meter is disposed in the water conduit for sensing a water flow through the water conduit and for providing a water flow signal indicative thereof. A microprocessor is disposed in the housing and connected to the water flow meter for determining the amount of water dispensed through the faucet spout in dependence upon the water flow signal and for providing data indicative thereof.

According to the aspect of the present invention, there is provided a method for measuring an amount of water dispensed through a faucet spout. A water flow meter in fluid communication with the faucet spout senses a water flow through the faucet spout and provides a water flow signal indicative thereof. A microprocessor connected to the water flow meter determines the amount of water dispensed through the faucet spout in dependence upon the water flow signal and providing data indicative thereof.

According to the aspect of the present invention, there is provided a device for measuring an amount of water dispensed through a faucet spout. The device comprises a water flow meter disposed in the faucet spout for sensing a water flow through the water conduit and for providing a water flow signal indicative thereof. A microprocessor is connected to the water flow meter for determining the amount of water dispensed through the faucet spout in dependence upon the water flow signal and for providing data indicative thereof.

The advantage of the present invention is that it provides a device and method for measuring an amount of water dispensed through a faucet spout.

A further advantage of the present invention is that it provides a device for measuring an amount of water dispensed through a faucet spout that is sufficiently small for being attached to or integrated into a faucet spout.

A further advantage of the present invention is to provide a device and method for measuring a temperature of water dispensed through a faucet spout.

A further advantage of the present invention is to provide a device for measuring an amount of water dispensed through a faucet spout that enables wireless communication therewith.

### BRIEF DESCRIPTION OF THE DRAWINGS

A preferred embodiment of the present invention is described below with reference to the accompanying drawings, in which:

FIGS. 1a to 1c are simplified block diagrams illustrating in a side view, a top view, and a cross-sectional view, respectively, a device for measuring an amount of water dispensed through a faucet spout according to a preferred embodiment of the invention;

FIGS. 1d and 1e are simplified block diagrams illustrating human machine interfaces of the device for measuring an amount of water dispensed through a faucet spout according to a preferred embodiment of the invention;

FIG. 1f is a simplified block diagram illustrating in a side view attachment to a faucet of the device for measuring an amount of water dispensed through a faucet spout according to a preferred embodiment of the invention;

FIG. 2 is a simplified block diagram illustrating in a cross-sectional view a device for measuring an amount of water dispensed through a faucet spout according to another preferred embodiment of the invention;

FIG. 3 is a simplified block diagram illustrating in a cross-sectional view a device for measuring an amount of water dispensed through a faucet spout according to yet another preferred embodiment of the invention; and,

FIG. 4 is a simplified block diagram illustrating in a side view a device for measuring an amount of water dispensed through a faucet spout according to yet another preferred embodiment of the invention.

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

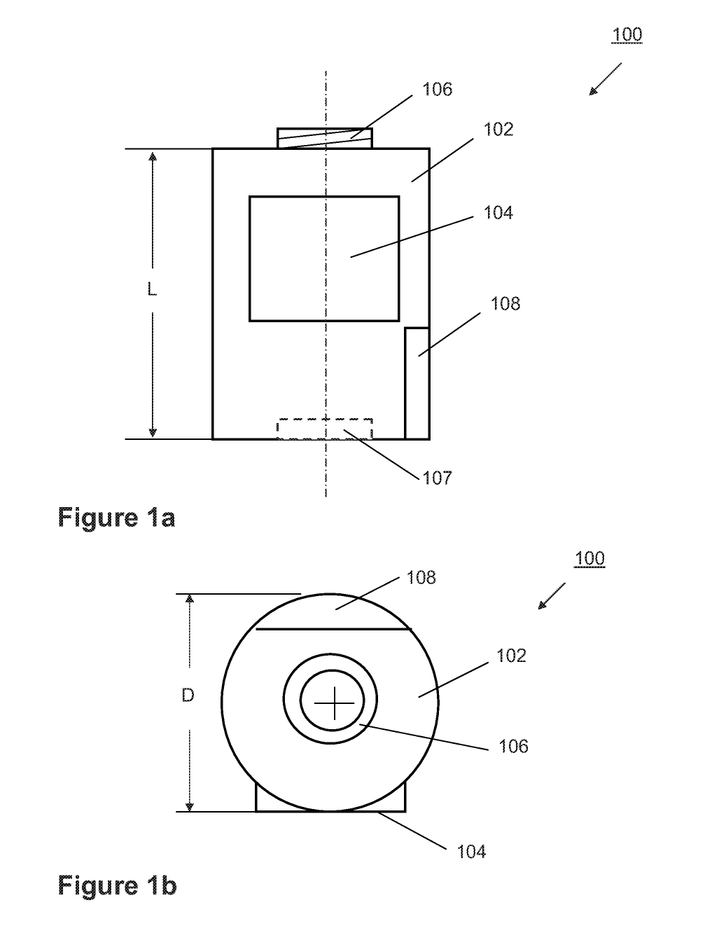

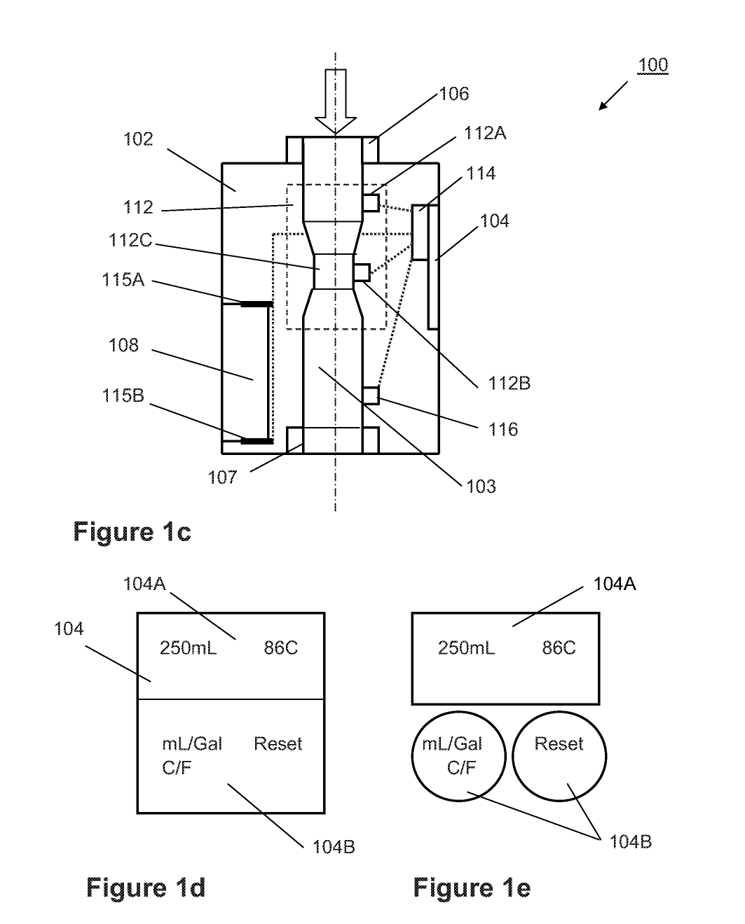

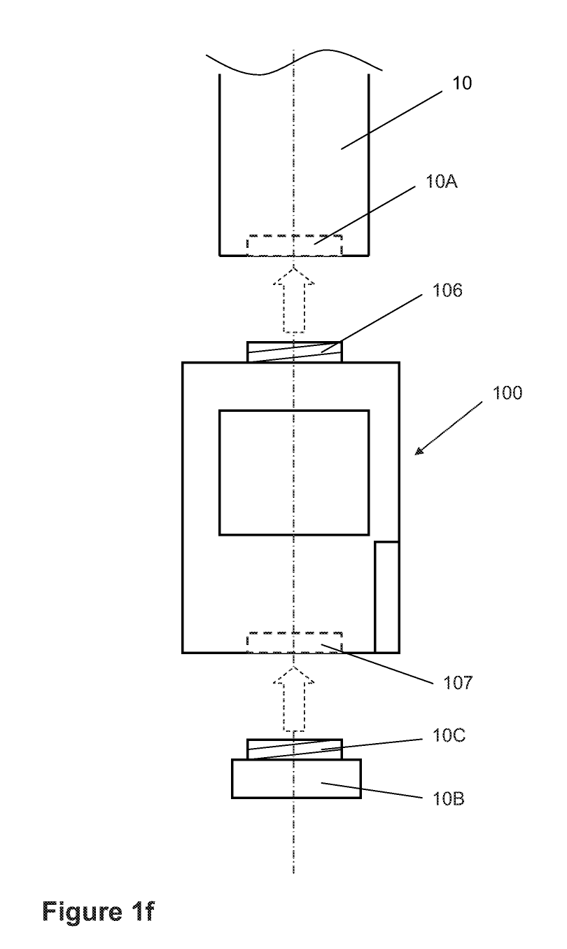

Referring to FIGS. 1a to 1f, a device for measuring an amount of water dispensed through a faucet spout 100 according to a preferred embodiment of the invention is provided. The device 100 comprises housing 102 having water conduit 103 disposed therein. A first end of the water conduit is adapted for being mounted to a faucet spout 10. Preferably, the first end of the water conduit 103 comprises a standard size male screw thread connector 106 for being mated with a respective standard size female screw thread connector 10A of the faucet spout 10. Further preferably, a second end of the water conduit 103 comprises a standard size female screw thread connector 107 for being mated with a respective standard size male screw thread connector 10C of, for example, an aerator 10B or a swivel head, of the faucet spout 10. The device 100 is then easily mounted to the faucet spout 10 by unscrewing the aerator 10B or a swivel head from the faucet spout 10 and interposing the device 100 therebetween, as illustrated in FIG. 1f.

Water flow meter 112 is disposed in the water conduit 103 for sensing a water flow through the water conduit 103 and for providing a water flow signal indicative thereof. Microprocessor 114 is disposed in the housing 102 and connected to the water flow meter 112. The microprocessor 114, for example, a conventional off-the-shelf Field-Programmable Gate Array (FPGA), determines the amount of water dispensed through the faucet spout in dependence upon the water flow signal received from the water flow meter 112 and provides data indicative thereof, which are displayed in human comprehensible form using Human Machine Interface (HMI) 104 connected to the microprocessor 114. The HMI 104 is further adapted for receiving user instructions and providing the same to the microprocessor 114.

The water flow meter 112 is, for example, a conventional Venturi-type water flow meter where the water flow rate is determined based on a difference in the static water pressure measured outside, pressure sensor 112A, and inside, pressure sensor 112B, a constricted section 112C of the water conduit 103. As is evident to one skilled in the art, there are numerous other types of flow meters employable for measuring the water flow in the device 100 such as, for example, mechanical, optical, or, acoustic.

Optionally, temperature sensor 116 is disposed in the water conduit 103 and connected to the processor 114. The temperature sensor 116 is, for example, a conventional off-the-shelf thermocouple sensor or thermistor sensor.

Electric power is provided to the microprocessor 114, the HMI 104, and the sensors 112A, 112B, and 116 using a battery such as, for example, an AAA cell type battery, or a button cell type battery, accommodated in battery compartment 108 and in contact with electric contacts 115A and 115B disposed therein. Alternatively, photovoltaic cells disposed on the outside surface of the housing 102 are employed for providing the electric power.

The HMI 104 is, for example, a touch screen having a display section 104A and a user input section 104B, as illustrated in FIG. 1d, or a display 104A and buttons 104B, as illustrated in FIG. 1e. The HMI 104 is implemented using conventional display technologies such as, for example, Liquid Crystal Display (LCD) or Light Emitting Diode (LED) technologies. Preferably, the HMI 104 is implemented in a waterproof fashion.

While water is dispensed through the faucet spout 10, the water flow meter 112 senses the water flow and provides a water flow signal indicative thereof to the microprocessor 114. The microprocessor 114 determines the amount of water dispensed through the faucet spout 10 in dependence upon the water flow signal and provides data indicative thereof which are then displayed using the HMI 104. Optionally, the temperature sensor 116 senses a temperature of the water flowing through the faucet spout and provides temperature data indicative thereof to the microprocessor 114. The microprocessor 114 then provides the temperature data to the HMI 104 for display. Optionally, the temperature is displayed using a colour code such as, for example, red for hot and blue for cold or varying colour intensities of red and blue.

The user input section 104B or buttons 104B enable the user, for example, to: select units—metric or imperial—for the amount of water, and Celsius or Fahrenheit for the water temperature; and to reset the display after use, as illustrated in FIGS. 1d and 1e.

Optionally, the microprocessor resets the display after elapse of a predetermined time interval, for example, 30 seconds, after the water flow signal is indicative of the water flow being shut off.

Further optionally, the microprocessor turns the display off after elapse of a predetermined time interval, for example, 30 seconds, after the water flow signal is indicative of the water flow being shut off and turns the display on when the water flow signal is indicative of the water flow being turned on or when the user input section 104B is indicative of a user input.

The housing 102 is made of, for example, a plastic material such as PolyEthylene (PE) or PolyVinyl Chloride (PVC) using a conventional plastic molding process. Alternatively, the housing 102 may be made of a metal, or ceramic. The housing 102 is of a compact design forming, for example, a cylinder having a length of 5-9 cm and a diameter of 3-6 cm. Of course, the housing may be designed having various shapes and colours to match the appearance of the faucet spout 10.

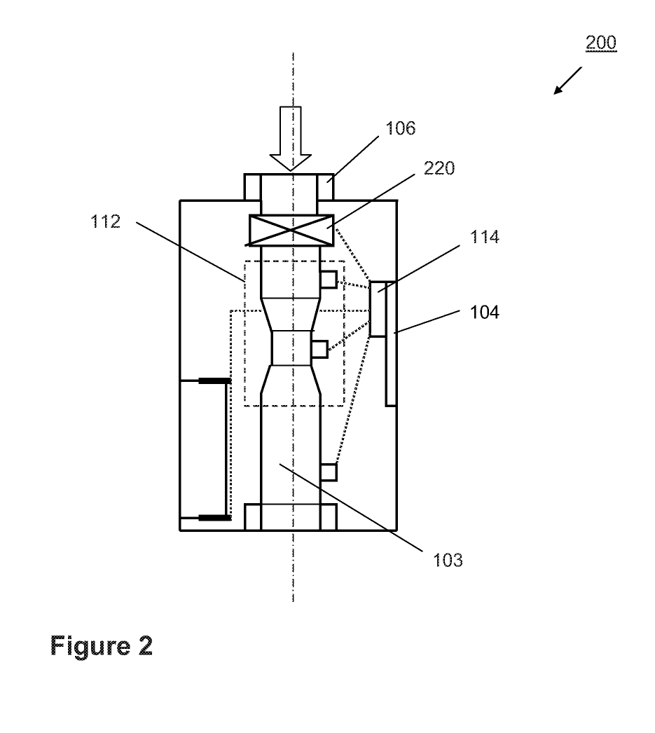

Referring to FIG. 2, a device for measuring an amount of water dispensed through a faucet spout 200 according to another preferred embodiment of the invention is provided. The device 200 comprises same components as the device 100 plus an electromechanically operated valve 220—such as, for example, a conventional solenoid valve—disposed in the water conduit 103 and connected to the processor 114. The microprocessor 114 in communication with the HMI 104 receives user instructions indicative of a predetermined amount of water to be dispensed from the faucet spout 10. For example, the user is enabled to select a desired amount of water using a scroll-down menu or Up/Down buttons. The microprocessor 114—in communication with the water flow meter 112 and the electromechanically operated valve 220—controls opening and closing of the electromechanically operated valve 220 such that the predetermined amount of water is dispensed.

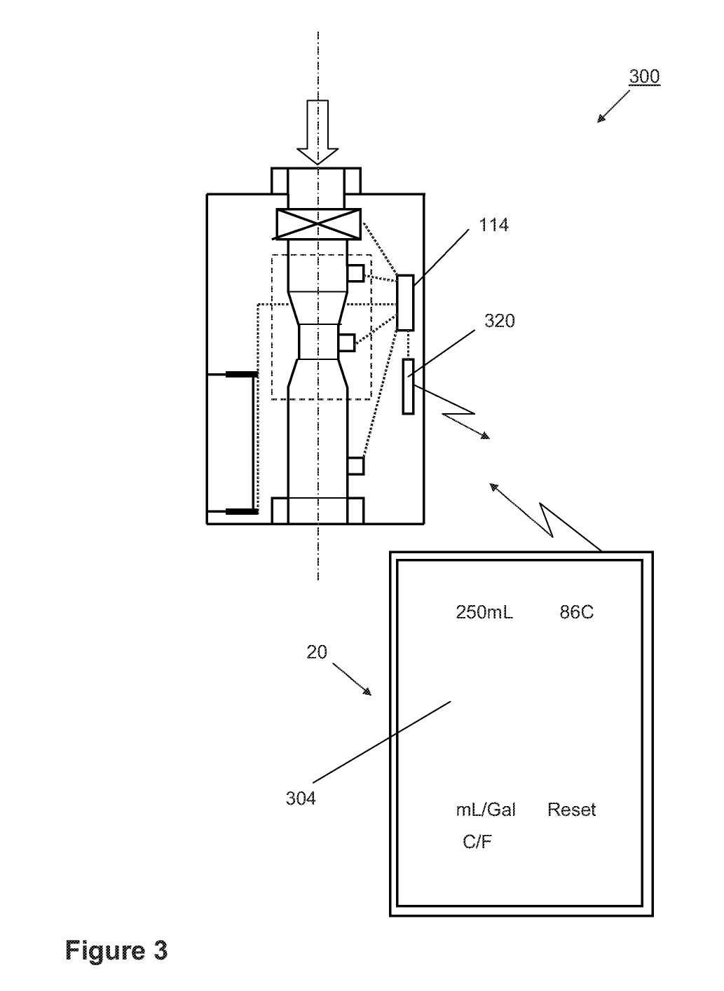

Referring to FIG. 3, a device for measuring an amount of water dispensed through a faucet spout 300 according to yet another preferred embodiment of the invention is provided. The device 300 comprises same components as the device 200 except that the HMI 104 is replaced by a conventional Radio Frequency (RF) transceiver 320 enabling wireless communication with a respective RF transceiver of a mobile device 20 such as, for example, a smart phone or tablet computer. User interaction with the device 300 is then enabled, for example, by executing respective mobile application software on the mobile device 20, thus using the touchscreen of the same as HMI 304. Using wireless communication in the device 300 instead of the HMI 104 enables provision of the same in a smaller housing 102 while enabling at a same time provision of a larger HMI 304.

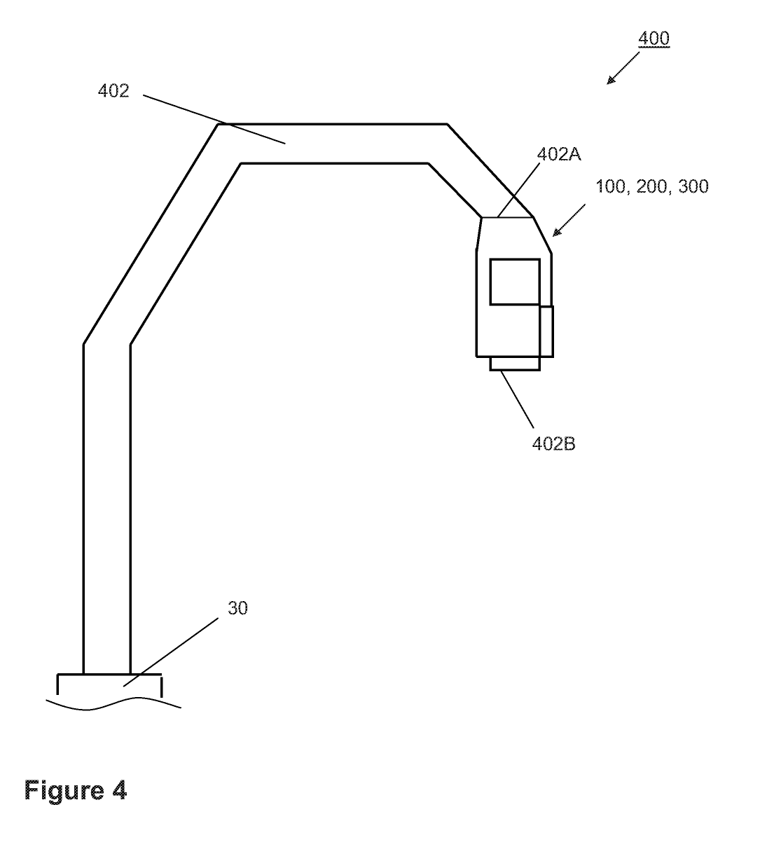

Referring to FIG. 4, a device for measuring an amount of water dispensed through a faucet spout 400 according to yet another preferred embodiment of the invention is provided. Here, a device 100, 200, or 300 is integrated into the faucet spout 402, preferably, interposed between the end 402A thereof and aerator or swivel head 402B. The device 400 is then mounted to faucet 30 in a conventional manner.

It will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A device for measuring an amount of water dispensed through a faucet spout comprising:
a. a housing capable of removeable attachment to the water spout;
b. a water conduit disposed in the housing, a first end of the water conduit for being engaged with the faucet spout; and
c. a water flow meter disposed in the water conduit for volumetrically measuring water flow through the water conduit and for providing a visual indication of such volumetric water flow.

2. The device of claim 1 further comprising a microprocessor disposed in the housing and connected to the water flow meter for determining the amount of water dispensed through the faucet spout in dependence upon the water flow signal and for providing data indicative thereof.

3. The device of claim 2 comprising a human machine interface connected to the microprocessor for receiving user instructions and for displaying the data indicative of the amount of water dispensed through the faucet spout.

4. The device of claim 1 wherein the first end of the water conduit comprises a male screw thread connector for being mated with a respective female screw thread connector of the faucet spout.

5. The device of claim 4 wherein a second end of the water conduit comprises a female screw thread connector.

6. The device of claim 1 comprising an electromechanically operated valve disposed in the water conduit.

7. The device of claim 2 comprising a temperature sensor disposed in the water conduit and connected to the processor.

8. The device of claim 2 comprising a transceiver connected to the microprocessor for receiving user instructions via wireless communication.

9. A method for measuring an amount of water dispensed through a faucet spout comprising:
a. using a water flow meter in fluid communication with the faucet spout sensing a water flow through the faucet spout and providing a water flow signal indicative thereof; and,
b. using a microprocessor connected to the water flow meter determining the amount of water dispensed through the faucet spout in dependence upon the water flow signal and providing data indicative thereof.

10. The method of claim 9 comprising using a display displaying the data indicative of the amount of water dispensed through the faucet spout.

11. The method of claim 10 comprising resetting the displayed data after elapse of a predetermined time interval after the water flow signal is indicative of the water flow being shut off.

12. The method of claim 10 comprising turning the display off after elapse of a predetermined time interval after the water flow signal is indicative of the water flow being shut off and turning the display on when the water flow signal is indicative of the water flow being turned on.

13. The method of claim 10 comprising:
a. using a temperature sensor sensing a temperature of the water flowing through the faucet spout and providing temperature data indicative thereof; and,
b. using the display displaying the temperature data.

14. The method of claim 13 wherein the temperature data are displayed using a colour code.

15. The method of claim 9 comprising:
a. using the microprocessor in communication with a human machine interface receiving user instructions indicative of a predetermined amount of water to be dispensed from the faucet spout; and,
b. the microprocessor in communication with the water flow meter and an electromechanically operated valve in fluid communication with the faucet spout controlling opening and closing of the electromechanically operated valve such that the predetermined amount of water is dispensed.

16. The method of claim 15 wherein the microprocessor communicates with the human machine interface via wireless communication.

17-19. (canceled)
